(19) United States
(12) Patent Application Publication
(10) Pub. No.: US 2012/0011223 A1
(43) Pub. Date: Jan. 12, 2012

(54) CENTRALIZED WEB BROWSING PROFILE

(75) Inventor: Leigh M. Rothschild, Sunny Isles Beach, FL (US)

(73) Assignee: LMR INVENTIONS, LLC, Sunny Isles Beach, FL (US)

(21) Appl. No.: 12/834,864

(22) Filed: Jul. 12, 2010

(51) Int. Cl. G06F 15/173; G06F 15/16

(52) U.S. Cl. 709/219; 709/223

(57) ABSTRACT

Embodiments of the present invention provide a method, system and computer program product for centralized cookie management. In an embodiment of the invention, a method for centralized cookie management includes receiving a request in a content browser executing in memory by at least one processor of a computer to retrieve content on behalf of an end user from a content server. The method further includes diverting transmission of the request from the content server to a centralized cookie repository remote from the content browser and the content server. The method yet further includes retrieving profile data for the end user in the centralized cookie repository, formulating a cookie from the profile data and combining the formulated cookie with the request. Finally, the method includes routing the request with the formulated cookie to the content server.

### BACKGROUND OF THE INVENTION

1. Field of the Invention

The present invention relates to content browsing over a computer communications network and more particularly to cookie processing during content browsing.

2. Description of the Related Art

Content browsing refers to the retrieval of content from a content source through a content browser from over a computer communications network. The most common form of content browsing pertains to Web page retrieval from the World Wide Web of documents, known by most as simply the “Web”. In a content browsing architecture, such as the Web, a network address of content is provided by the end user to a content browser. The content browser, in response, can formulate a content request to a content server at the network address and transmit the same to the content server. The response to the request can provide information such as whether or not the requested content can be located, or whether an error condition has arisen. In the former circumstance, the content can be included as part of the response and the content browser can render the returned content in the content browser, for example by processing markup language directives included in the returned content.

A large portion of the Web incorporates personalized delivery of content. Personalization ranges from recalling basic personal information such as name and address to consummate an e-commerce transaction, to complex and detailed demographic data and psychographic data such as attributes relating to personality, values, attitudes, interests, musical tastes, travel preferences, or lifestyles. To facilitate the personalization of content delivery to different individuals, for more than a decade content providers have utilized the venerable “cookie”. A “cookie” as it is well known in the art is a text string stored by a Web browser. A cookie consists of one or more name-value pairs containing bits of information, which may be encrypted for information privacy and data security purposes. In operation, the cookie is sent as a hypertext transfer protocol (HTTP) header by a web server to a web browser and then sent back unchanged by the Web browser each time the Web browser accesses the Web server.

Most end users of the Web have grown to mistrust the use of the cookie. This mistrust is embodied by the embedded “disable cookie” feature of most commercially available content browsers. Much of this mistrust is misguided because as text, cookies are not executable and since cookies are not executed, cookies cannot replicate themselves and are not viruses. However, due to the content browser mechanism to set and read cookies, cookies can be used as spyware. In fact, modern anti-spyware applications warn end users about some cookies because cookies can be used to track end users—a privacy concern. Thus, while most modern content browsers permit the end user to opt to reject the use of cookies, or more reasonably, a time period during which a cookie is to be maintained, rejecting cookies renders some Web sites unusable.

### BRIEF SUMMARY OF THE INVENTION

Embodiments of the present invention address deficiencies of the art in respect to cookie usage in content delivery and provide a novel and non-obvious method, system and computer program product for centralized cookie management. In an embodiment of the invention, a method for centralized cookie management includes receiving a request in a content browser executing in memory by at least one processor of a computer to retrieve content on behalf of an end user from a content server. The method further includes diverting transmission of the request from the content server to a centralized cookie repository remote from the content browser and the content server. The method yet further includes retrieving profile data for the end user in the centralized cookie repository, formulating a cookie from the profile data and combining the formulated cookie with the request. Finally, the method includes routing the request with the formulated cookie to the content server.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for centralized cookie management;

FIG. 2 is a schematic illustration of a content browsing data processing system configured for centralized cookie management; and,

FIG. 3 is a flow chart illustrating a process for centralized cookie management.

### DETAILED DESCRIPTION OF THE INVENTION

Embodiments of the invention provide for centralized cookie management. In an embodiment of the invention, different end users can register profile information with a centralized cookie repository. Thereafter, when an end user through a content browser configured for centralized cookie management establishes a new session with a specific content server from over a computer communications network, the network address of the specific content server can be provided to the centralized cookie repository along with an identifier for the end user. In response, the centralized cookie repository can provide all or a portion of the profile information of the end user to the content server in substitute for the use of a cookie by the content browser.

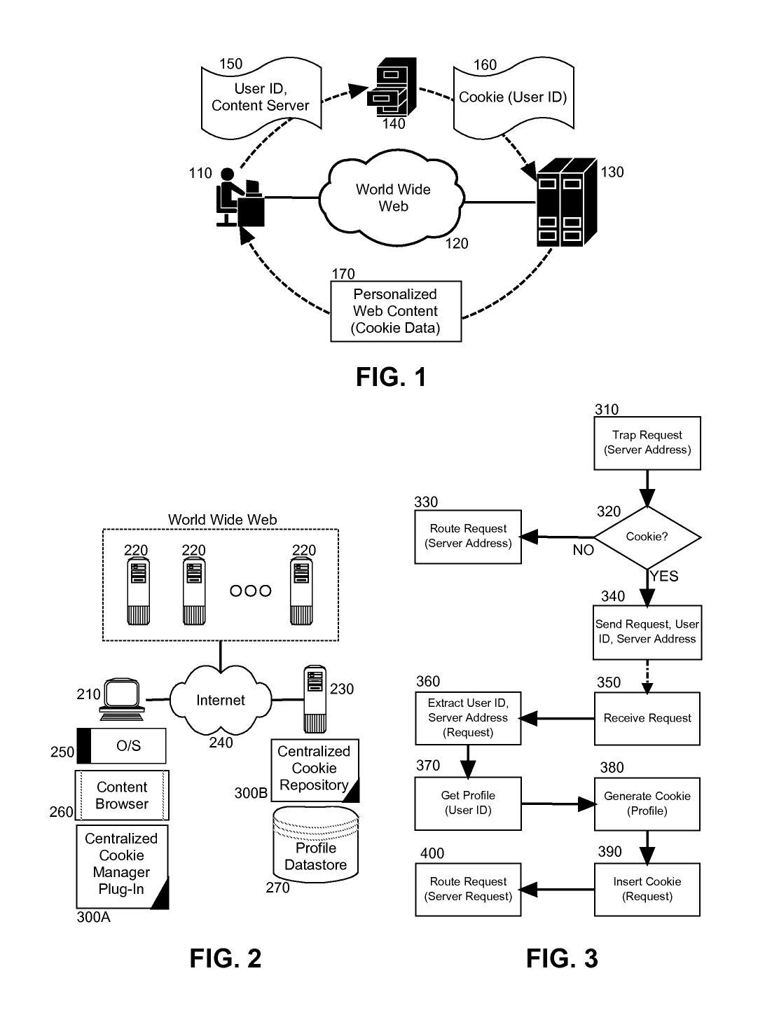

In illustration, FIG. 1 pictorially shows a process for centralized cookie management. As shown in FIG. 1, an end user 110 can establish a communicative session with a content server 130 over a content distribution network 120 like the Web. Specifically, the end user 110 through a Web browser can issue a request to the content server 130 in the form of a URL that includes a network address of the content server 130. In response to the request, a message 150 including an identifier for the end user 110 and also the address of the content server 130 can be provided to a centralized cookie repository 140. The centralized cookie repository 140 in turn can lookup profile data for the end user 110 stored in the centralized cookie repository 140 and the centralized cookie repository 140 can formulate a cookie 160 for the end user 110. Finally, the centralized cookie repository 140 can forward the formulated cookie 160 to the content server 130 as if the end user 110 had forwarded the cookie 160 directly to the content server 130. In response, personalized content 170 can be returned from the content server 130 to the end user 110.

The process described in connection with FIG. 1 can be implemented in a content distribution data processing system. In further illustration, FIG. 2 schematically shows a content browsing data processing system configured for centralized cookie management. The system can include a computer 210 configured for communicative coupling both to a host server 230 and one or more content servers 220 over computer communications network 240. The computer 210 can include at least one processor and memory in which an operating system 250 can execute. The operating system 250 in turn can host the operation of content browser 260 such that content can be retrieved upon request from the content servers 220 for rendering in the content browser 260.

Of note, centralized cookie manager plug-in 300A can be coupled to the content browser 260. The centralized cookie manager plug-in 300A can include program code that when executed by the processor of the computer 210 can trap a request to establish a session with a content server 220 originating from the content browser 260. The program code of the centralized cookie manager plug-in 300A further upon execution can transmit to centralized cookie repository 300B in the host server 230 the trapped request along with an identity of an end user issuing the request. The centralized cookie repository 300B in turn can retrieve profile data for the end user from profile data store 270. The profile data can include, by way of example, personally identifying data, payment processing data, demographic data, psychographic data and the like. Therefore, a cookie can be generated with the profile data for the end user and included with the request for routing to the content server 220 as if the original request had not first been trapped by the program code of the centralized cookie manager plug-in 300A

In even yet further illustration of the operation of the centralized cookie manager plug-in 300A and the centralized cookie repository 300B, FIG. 3 is a flow chart depicting a process for centralized cookie management. Beginning in block 310, a request can be received from an end user by way of content browser for establishing a session with a content server. The request can include a uniform resource locator of a resource accessible over a content distribution network such as the Web and at the minimum can include a network addressable location of at least one Web page. In decision block 320, it can be determined whether or not a cookie is to be transmitted to the content server referenced by the request. If not, in block 330 the request can be routed directly from the content browser to the content server. Otherwise, the request can be routed to the centralized cookie repository along with an identifier of the end user and the process can continue through block 350.

In block 350, the request can be received in the centralized cookie repository and in block 360, the user identifier can be retrieved. In block 370, a profile can be retrieved for the user identifier and in block 380, a cookie can be formulated using the profile. In block 390, the formulated cookie can be combined with the request to form a request with a cookie included therewith. Finally, in block 400 the request with the cookie can be forwarded to the content server. In this way, the benefit of cookie use can be achieved without exposing the end user to the potential abuse of privacy that can result from local cookie usage.

As will be appreciated by one skilled in the art, aspects of the present invention may be embodied as a system, method or computer program product. To that end, aspects of the present invention may take the form of a computer program product embodied in one or more computer readable media having computer readable program code embodied thereon. Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for centralized cookie management comprising:
receiving a request in a content browser executing in memory by at least one processor of a computer to retrieve content on behalf of an end user from a content server;
diverting transmission of the request from the content server to a centralized cookie repository remote from the content browser and the content server;
retrieving profile data for the end user in the centralized cookie repository;
formulating a cookie from the profile data and combining the formulated cookie with the request; and,
routing the request with the formulated cookie to the content server.

2. The method of claim 1, wherein receiving a request in a content browser to retrieve content on behalf of an end user from a content server, comprises trapping a request in a content browser to retrieve content on behalf of an end user from a content server.

3. The method of claim 1, wherein retrieving profile data for the end user in the centralized cookie repository, comprises retrieving demographic data for the end user in the centralized cookie repository.

4. The method of claim 1, wherein retrieving profile data for the end user in the centralized cookie repository, comprises retrieving psychographic data for the end user in the centralized cookie repository.

5. The method of claim 1, wherein retrieving profile data for the end user in the centralized cookie repository, comprises retrieving payment processing data for the end user in the centralized cookie repository.

6. A content browsing data processing system comprising:
a computer with at least one processor and memory configured for communicative coupling to a centralized cookie repository executing in memory by at least one processor of a host server;
a content browser executing in the computer; and,
a centralized cookie management module coupled to the content browser, the module comprising program code enabled to receive a request in the content browser, divert the request to the centralized cookie repository over a computer communications network along with a user identifier for a user initiating the request;
the centralized cookie repository comprising program code enabled to retrieve from a profile data store profile data for an end user corresponding to a provided identifier, to formulate a cookie with the profile data and to route the formulated cookie with a diverted request to a specified content server.

7. The system of claim 5, wherein the centralized cookie management module is a plug-in to the content browser.

8. A computer program product for centralized cookie management, the computer program product comprising:
a computer readable storage medium having computer readable program code embodied therewith, the computer readable program code comprising:
computer readable program code for receiving a request in a content browser to retrieve content on behalf of an end user from a content server;
computer readable program code diverting transmission of the request from the content server to a centralized cookie repository remote from the content browser and the content server;
computer readable program code retrieving profile data for the end user in the centralized cookie repository;
computer readable program code formulating a cookie from the profile data and combining the formulated cookie with the request; and,
computer readable program code routing the request with the formulated cookie to the content server.
